(19) United States
(12) Patent Application Publication
(10) Pub. No.: US 2021/0397560 A1
(43) Pub. Date: Dec. 23, 2021

(54) Cache stashing system

(71) Applicant: MELLANOX TECHNOLOGIES, LTD., Yokneam (IL)

(72) Inventors: Ilan Pardo, Ramat Hasharon (IL); Hillel Chapman, Ramat HaShofet (IL); Mark B. Rosenbluth, Uxbridge, MA (US)

(21) Appl. No.: 16/907,347

(22) Filed: Jun. 22, 2020

(51) Int. Cl. G06F 12/0891; G06F 12/0817; G06F 12/0804; G06F 9/54; H04L 29/08; H04L 29/06

(52) U.S. Cl. CPC G06F 12/0891; G06F 12/0824; G06F 12/0804; H04L 69/22; G06F 9/544; H04L 67/1097; G06F 9/546

(57) ABSTRACT

In one embodiment, a computer server system includes a memory to store data across memory locations, multiple processing cores including respective local caches in which to cache cache-lines read from the memory, an interconnect to manage read and write operations of the memory and local caches, maintain local cache location data of the cached cache-lines according to respective ones of the memory locations from which the cached cache-lines were read from the memory, receive a write request for a data element to be written to one of the memory locations, find a local cache location in which to write the data element responsively to the local cache location data and the memory location of the write request, and send an update request to a first processing core to update a respective first local cache with the data element responsively to the found local cache location.

### FIELD OF THE INVENTION

The present invention relates to computer systems, and in particular, but not exclusively to, cache loading.

### BACKGROUND

In multicore systems, buffers in a memory (e.g., in DRAM) are allocated to each of the cores. The buffers are managed by the cores and buffer space may also be allocated to a network interface controller (NIC) which transfers packets between the cores and devices in a network. Packet data which is received from the network destined for a particular core is stored along with a descriptor in the buffer in the memory allocated to that core. In some systems, receive-side scaling (RSS) may be used by the MC to classify received packets and place the received packet data into respective queues associated with respective cores based on the classification. The NIC may also notify the core (e.g., via an interrupt) that there is received packet data in memory from where the packet descriptor and then the packet data (e.g., packet payload) are retrieved by the core for updating its local cache. Similar processes may be used for other peripheral devices such as non-volatile memory express (NYMe) solid state drive (SSD) devices.

### SUMMARY

There is provided in accordance with an embodiment of the present disclosure, a computer server system, including a memory configured to store data. across memory locations, multiple processing cores including respective local caches in which to cache cache-lines read from the memory, an interconnect configured to manage read and write operations of the memory and the local caches, maintain local cache location data of the cached cache-lines respective ones of the memory locations from which the cached cache-lines were read from the memory, receive a write request for a data element to be written to one of the memory locations, find a local cache location in which to write the data element responsively to the local cache location data and the memory location of the write request, and send an update request to a first one of the processing cores to update a respective first one of the local caches with the data element responsively to the found local cache location.

Further in accordance with an embodiment of the present disclosure the first processing core is configured to update the first local cache with the data element responsively to the sent update request.

Still further in accordance with an embodiment of the present disclosure the interconnect includes a directory configured to store the local cache location data of the cached cache-lines respective ones of the memory locations of the cached cache-lines, and the interconnect is configured to query the directory responsively to the memory location of the write request yielding the found local cache location.

Additionally, in accordance with an embodiment of the present disclosure, the system includes an interface controller configured to receive a packet from at least one device, the packet including the data element, and generate the write request.

Moreover, in accordance with an embodiment of the present disclosure the interface controller is configured to tag the write request with an indication to push the data element to the first local cache even though local cache locations are unknown to the interface controller.

Further in accordance with an embodiment of the present disclosure the interface controller is configured to classify the received packet responsively to header data of the received packet, find one of the memory locations to which to write the data element of the received packet responsively to the classification of the received packet, and generate the write request for the data element responsively to the found memory location.

Still further in accordance with an embodiment of the present disclosure the interface controller is configured to find a queue for the received packet responsively to the classification of the received packet, find a buffer descriptor for the received packet responsively to the found queue, and find the memory location to which to write the data element of the received packet responsively to the found buffer descriptor.

Additionally, in accordance with an embodiment of the present disclosure the interface controller includes a network interface controller to manage receiving packets over a network, the at least one device including at least one node in the network.

Moreover, in accordance with an embodiment of the present disclosure the interface controller includes a peripheral device controller and the at least one device includes at least one peripheral device.

Further in accordance with an embodiment of the present disclosure the at least one peripheral device includes one or more of the following a disk drive, or a hardware accelerator.

There is also provided in accordance with another embodiment of the present disclosure, a computer server method, including storing data in a memory across memory locations, caching cache-lines read from the memory in local caches of multiple processing cores, managing read and write operations of the memory and the local caches, maintaining local cache location data of the cached cache-lines respective one of the memory locations from which the cached cache-lines were read from the memory, receiving a write request for a data element to be written to one of the memory locations, finding a local cache location in which to write the data element responsively to the local cache location data and the memory location of the write request, and sending an update request to a first one of the processing cores to update a respective first one of the local caches with the data element responsively to the found respective local cache location.

Still further in accordance with an embodiment of the present disclosure, the method includes updating the first local cache with the data element responsively to the sent update request.

Additionally in accordance with an embodiment of the present disclosure, the method includes storing in a. directory the local cache location data of the cached cache-lines respective ones of the memory locations of the cached cache-lines, and querying the directory responsively to the memory location of the write request yielding the found local cache location.

Moreover, in accordance with an embodiment of the present disclosure, the method includes receiving a packet from at least one device, the packet including the data element, and generating the write request.

Further in accordance with an embodiment of the present disclosure, the method includes tagging, by an interface controller, the write request with an indication to push the data element of the packet to the first local cache even though local cache locations are unknown to the interface controller.

Still further in accordance with an embodiment of the present disclosure, the method includes classifying the received packet responsively to header data of the received packet, finding one of the memory locations to which to write the data element of the received packet responsively to the classification of the received packet, and generating the write request for the received packet responsively to the found memory location.

Additionally in accordance with an embodiment of the present disclosure, the method includes finding a queue for the received packet responsively to the classification of the received packet, finding a buffer descriptor for the received packet responsively to the found queue, and finding the memory location to which to write the data element of the received packet responsively to the found buffer descriptor.

Moreover, in accordance with an embodiment of the present disclosure the receiving the packet is performed by a network interface controller, the method further including the network interface controller managing receiving packets over a network, the at least one device including at least one node in the network.

Further in accordance with an embodiment of the present disclosure the receiving the packet is performed by a peripheral device controller and the at least one device includes at least one peripheral device.

Still further in accordance with an embodiment of the present disclosure the at least one peripheral device includes one or more of the following a disk drive, or a hardware accelerator.

### BRIEF DESCRIPTION OF THE DRAWINGS

The present invention will be understood from the following detailed description, taken in conjunction with the drawings in which:

FIG. 1 is a block diagram view of a computer server system constructed and operative in accordance with an embodiment of the present invention;

FIG. 2 is a flowchart including steps in a method of operation of an interconnect in the system of FIG. 1;

FIG. 3 is a flowchart including steps in a method of operation of an interface controller in the system of FIG. 1;

FIG. 4 is a flowchart including steps in a method of managing local cache updates in the system of FIG. 1; and

FIG. 5 is a flowchart including steps in a method of updating local caches in the system of FIG. 1.

### DESCRIPTION OF EXAMPLE EMBODIMENTS

### Overview

As previously mentioned, in a multicore system, a network interface controller (NIC) may notify the relevant core (e.g., via an interrupt) that there is received packet data in memory (e.g., DRAM or SRAM) from where the packet descriptor and then the packet data are retrieved by the core for updating its local cache. For example, using Peripheral Component Interconnect express (PCIe) Message Signaled Interrupt (MSI/MSI-x) an interrupt message is targeted to the correct core but the descriptor and packet data is written typically to a memory location in memory and not to the core's local cache. A scheme known as Receive Side Scaling (RSS), may be used to write the descriptor and packet data into a dedicated queue which is typically associated with a core, avoiding contention of different cores access to shared queue. However, the NIC hardware is typically unaware of which queue belongs to which core.

The above methods lack performance as the packet data is first written to memory and not the relevant local cache. Performance may be improved by directly writing the packet data to the relevant cache.

A possible solution to the above problem is making the NIC aware to which core an RSS queue is associated in order for the NIC to push the data into the core's cache. This solution is dependent on particular support of the feature in the NIC and is therefore sub-optimal and device dependent.

Embodiments of the present invention solve the above problems by writing packet descriptor and payload data directly to the relevant local cache location at the central processing unit (CPU) chip interconnect level of the device hosting the multicore system. Therefore, support and resulting efficiency may be achieved with any NIC or other suitable device using memory buffers (for example, allocated by the CPU to the NIC or other suitable device) to transfer data to the CPU software regardless of NIC (or other device) support. In some embodiments, the CPU may be replaced by a graphics processing unit (GPU) or any suitable processing device.

In some embodiments, any suitable data elements (e.g., payload data or other data) may be directly written to the relevant local cache location whether the data elements come from a NIC, another interface controller or another element, such as a graphics processing unit (GPU) or another CPU.

It is assumed that the information tracked as part of a memory coherence protocol provides a best estimate of where payload data should be written to in the local caches based on recent history of the local caches with respect to the same memory locations (e.g., memory addresses) that the payload data would be written to if it was written directly to memory. Therefore, the CPU interconnect uses information tracked as part of the memory coherence protocol (described in more detail below) which tracks local cache usage by memory location (e.g., memory address) from which cache lines are read from memory by the processing cores. The tracked information includes the cached memory locations and their current corresponding local cache locations. The interconnect processes write requests from the NIC (to write payload data) by finding cache locations corresponding with memory locations included in the write requests and instructs the relevant cores to update their local caches accordingly with received payload data. If corresponding cache locations for some memory locations are not found, the relevant payload data is written to memory at the respective memory locations.

Memory coherence is an issue that affects the design of computer systems in which two or more processors or cores share a common area of memory. In multiprocessor or multicore systems, there are two or more processing elements working at the same time, and so it is possible that they simultaneously access the same memory location. Provided none of them changes the data in this location, they can share it indefinitely and cache it as they want. But as soon as one updates the location, the others might work on an out-of-date copy that, e.g., resides in their local cache. Consequently, a scheme (for example, a memory coherence protocol) is required to notify all the processing elements of changes to shared values providing the system with a coherent memory. The coherency protocol may be directory based and/or snooping based, for example.

Therefore, in such a multicore system, reads and writes to the memory as well as cache updates are managed according to a memory coherence protocol, in which the CPU interconnect maintains a directory which includes a table listing the cache locations of currently locally cached cache lines and their associated state and memory location (e.g., memory address) from which the cache lines were read from the memory, e.g., DRAM or SRAM.

For example, whenever a core accesses a memory location in DRAM which is not already in a local cache, the CPU interconnect is informed that the access has occurred and keeps track of the cached memory location via the memory location using the table in the directory.

By way of another example, if a core requests to read a line from the DRAM, the CPU interconnect receives the read request and checks the directory to check whether the most updated version associated with that memory location is in DRAM or a local cache. The most up to date version of the data may then be used by the requesting core.

By way of yet another example, if a core wants to update a cached cache line, that core informs the interconnect about the update, and all other cached copies (as listed in the directory) of that cache line are invalidated. The interconnect may send a snoop request to invalidate the other cache lines and then gives that core write permission to the whole cache line for that memory location.

By way of example, for a write transaction, the CPU interconnect may receive a write request to write data to a memory location in memory. The CPU interconnect checks the directory to determine if there is a cached copy of that memory location. If there is a cached copy, the CPU interconnect may send a snoop request to the relevant core(s) to invalidate their copy. After receiving confirmation of invalidation, the CPU interconnect writes the data to the memory (e.g., DRAM) at that memory location.

In embodiments of the present invention, upon receiving a write request from an interface controller such as a NIC, the CPU interconnect, instead of invalidating the copy on the relevant core, writes the data directly to the local cache of the relevant processing core according to the known cache location data in the directory. If there is not a cached copy in a local cache for that memory location, the data is written to the memory at that memory location.

Writing the data directly to the local cache has several advantages. First, round trip delay of snoop invalidation before forwarding the data is avoided. Second, regarding the packet descriptor, typically the relevant processing core polls the descriptor so that the memory address is cached in the correct core's local cache. Third, regarding packet data, a buffer pool (of the memory buffers assigned to the different cores) is typically implemented per core so the last packet using the memory buffer had been processed by the core that will process the new packet. In this case also the memory address is cached in the correct target core's local cache. Fourth, the CPU interconnect tracks cache locations naturally as part of its cache coherency implementation without the need for explicit comprehension of application type and behavior of the interface controller.

### System Description

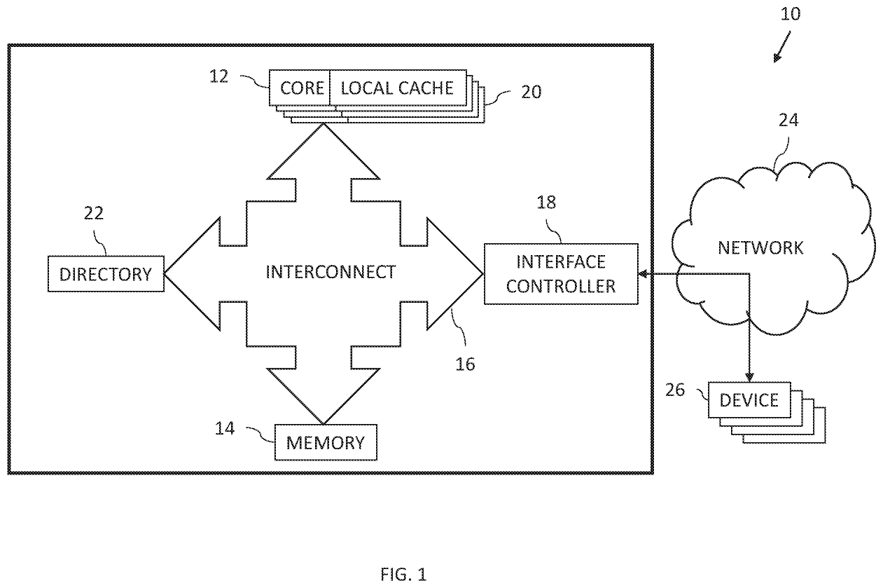

Reference is now made to FIG. 1, which is a block diagram view of a computer server system 10 constructed and operative in accordance with an embodiment of the present invention. The computer server system 10 includes multiple processing cores 12, a memory 14 (such as dynamic random-access memory (DRAM) or static random-access memory (SRAM)), a CPU interconnect 16, and an interface controller 18. The memory 14 is configured to store data across a plurality of memory locations. The processing cores 12 include respective local caches 20 (e.g. one local cache 20 per processing core 12) in which to cache cache-lines read from the memory 14 from ones of the memory locations in the memory 14. In some embodiments, the processing cores 12 may be comprised in a processing unit such as a central processing unit or a graphics processing unit (GPU). The CPU interconnect 16 may be replaced by any suitable interconnect, for example, but not limited to a GPU interconnect. The interconnect 16 includes a directory 22 configured to store local cache location data and state data of the cached cache-lines according to respective ones of the memory locations from which the cached cache-lines were read from the memory 14. The directory 22 may include a table indexed by memory location, and for each listed memory location include a corresponding local cache location in which data from the memory location is currently stored. Each listed memory location may also include a state of the corresponding cache line. The state may include: “dirty”, which indicates that the cached data has been modified from the corresponding data included in the memory 14; “clean”, which indicates that the cached data has not been modified; “exclusive”, which indicates that only one core has a copy of the data ; “shared”, which indicates that there are multiple copies of data cached from the memory 14. The states may depend on the coherency protocol being used. Cache lines removed from the cache are generally also removed from the table. The directory 22 is updated by the interconnect 16 which receives read and write requests as well as update notifications which are used to update the directory 22. The interconnect 16 also performs other memory coherence tasks according to any suitable memory coherence protocol.

The interface controller 18 may include any suitable interface controller, which receives packets from, and sends packets to, at least one device 26. In some embodiments, the interface controller 18 includes a network interface controller (NIC) to manage receiving packets over a network 24 from the device(s) 26, which may be a node (or nodes) in the network 24.

In some embodiments, interface controller 18 comprises a peripheral device controller and the device(s) 26 includes at least one peripheral device. In some embodiments, the peripheral device includes a disk drive and/or a hardware accelerator.

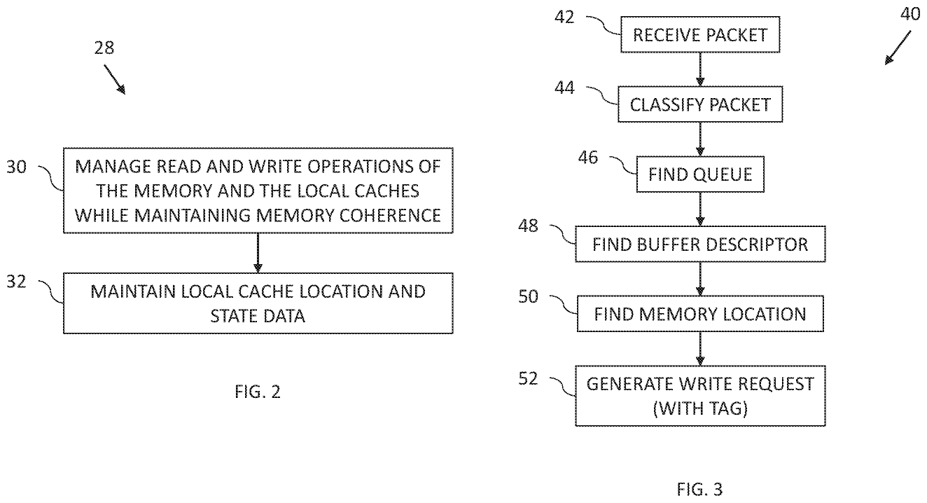

Reference is now made to FIG. 2, which is a flowchart 28 including steps in a method of operation of the interconnect 16 in the system 10 of FIG. 1. Reference is also made to FIG. 1. The interconnect 16 is configured to manage (block 30) read and write operations of the memory 14 and the local caches 20 including updates and invalidations of the local caches 20 while maintaining coherence of the memory in accordance with any suitable memory coherence protocol. The interconnect 16 is configured to maintain in the directory 22 (block 32) local cache location data and state data of the currently cached cache-lines according to the respective memory locations from which the cached cache-lines were read from the memory 14, The local cache data and state data may be stored in a table which is indexed according to memory location. For example, each cache line cached in the local caches 20 may include a line in the table including: memory location from which the cached cache line was read from the memory 14; a cache location where the cache line is cached in the local caches 20; and a state of the cache line.

Reference is now made to FIG. 3, which is a flowchart 40 including steps in a method of operation of an interface controller 18 in the system 10 of FIG. 1. Reference is also made to FIG. 1. The interface controller 18 is configured to receive (block 42) a packet from the device(s) 26. The interface controller 18 is configured to classify (block 44) the received packet responsively to header data of the received packet. The classification may be performed in accordance with any suitable mechanism, for example, but not limited to, RSS.

In some embodiments, the interface controller 18 is configured to find (block 46) a receive queues of the received packet (in which to post the received packet) responsively to the classification of the received packets. The interface controller 18 is configured to find (block 48) a buffer descriptor for the received packet responsively the found queue. The interface controller 18 is configured to find (block 50) a memory location to which to write the payload data of the received packet responsively to the classification of the received packet. In some embodiments, the interface controller 18 is configured to find the memory location to which to write the payload data of the received packet responsively to the found buffer descriptor.

In some embodiments, the interface controller 18 writes the payload data of the received packet into a memory buffer (a logical buffer which may be in any suitable physical location) from which the payload data is subsequently transferred to one of the local caches 20, and indication(s) (e.g., that the packet has arrived) and the buffer descriptor (e.g., a Completion Queue Element (CQE)) of the packet into a memory location.

The interface controller 18 is configured to generate (block 52) a write request for the payload data (of the received packet) to be written to the found memory location (found in the step of block 50). In some embodiments, the interface controller 18 is configured to tag the write request with an indication to push the payload data of the packet to one of the local caches 20 even though local cache locations are unknown to the interface controller.

In practice, some or all of the functions of the interface controller 18 may be combined in a single physical component or, alternatively, implemented using multiple physical components. These physical components may comprise hard-wired or programmable devices, or a combination of the two. In some embodiments, at least some of the functions of the interface controller 18 may be carried out by a programmable processor under the control of suitable software. This software may be downloaded to a device in electronic form, over a network, for example. Alternatively, or additionally, the software may be stored in tangible, non-transitory computer-readable storage media, such as optical, magnetic, or electronic memory.

The steps of blocks 42-52 described above may be repeated for subsequent packets or any other suitable data. The term “payload data” is used above and below as an example of a data element, and any other suitable data element may be substituted for the payload data.

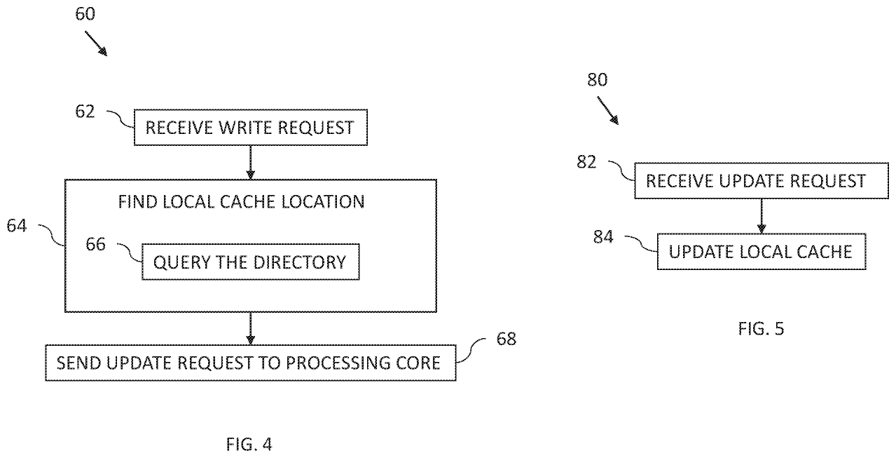

Reference is now made to FIG. 4, which is a flowchart 60 including steps in a method of managing local cache updates in the system 20 of FIG. 1. Reference is also made to FIG. 1.

The interconnect 16 is configured to receive (block 62) the write request (for payload data to be written to the memory location found by the interface controller 18) from the interface controller 18. The interconnect 16 is configured to find (block 64) a (currently used) local cache location of the local caches 20 in which to write the payload data of the received packet responsively to the local cache location data (stored in the directory 22) and the memory location of the write request. As a sub-step of the block 64, the interconnect 16 is configured to query (block 66) the directory 22 responsively to the memory location of the write request (e.g., the respective memory location included in the write request) yielding the local cache location of the local cache 20 in which to write the payload data of the received packet.

The interconnect 16 is configured to send an update request to respective the processing core 12 (associated with the found local cache location) to update (block 68) the respective local cache 20 with the payload data of the received packet responsively to the found (currently used) local cache location. In other words, an update request to update a certain local cache 20 with payload data of a packet is sent to the processing core 12 comprising that local cache 20 which comprises the relevant (currently used) local cache location found for that packet. If a memory location is not found in the step of block 66, meaning that the memory location is not associated with one of the currently cached cache lines, the interconnect 16 is configured to write the relevant payload data to that memory location in the memory 14.

In practice, some or all of the functions of the interconnect 16 may be combined in a single physical component or, alternatively, implemented using multiple physical components. These physical components may comprise hard-wired or programmable devices, or a combination of the two. In some embodiments, at least some of the functions of the interconnect 16 may be carried out by a programmable processor under the control of suitable software. This software may be downloaded to a device in electronic form, over a network, for example. Alternatively, or additionally, the software may be stored in tangible, non-transitory computer-readable storage media, such as optical, magnetic, or electronic memory.

The steps of blocks 62-68 described above may be repeated for subsequent write requests.

Reference is now made to FIG. 5, which is a flowchart 80 including steps in a method of updating local caches 20 in the system of FIG. 1. Reference is also made to FIG. 1. The relevant processing core 12 is configured to receive (block 82) the update request from the interconnect 16. In other words, each processing core 12 receives the update requests addressed to that processing core 12. The relevant processing core 12 is configured to retrieve the payload data of the respective packet from the memory buffer in which the payload data is stored and update the respective local cache 20 (i.e., each processing core 12 updates its own local cache 20) with the payload data of the respective packet responsively to the sent update request.

The steps of blocks 82-84 described above may be repeated for subsequent update requests.

In practice, some or all of the processing cores 12 may be combined in a single physical component or, alternatively, implemented using multiple physical components. These physical components may comprise hard-wired or programmable devices, or a combination of the two. In some embodiments, at least some of the functions of the processing cores 12 may be carried out by a programmable processor under the control of suitable software. This software may be downloaded to a device in electronic form, over a network, for example. Alternatively, or additionally, the software may be stored in tangible, non-transitory computer-readable storage media, such as optical, magnetic, or electronic memory.

Various features of the invention which are, for clarity, described in the contexts of separate embodiments may also be provided in combination in a single embodiment. Conversely, various features of the invention which are, for brevity, described in the context of a single embodiment may also be provided separately or in any suitable sub-combination.

The embodiments described above are cited by way of example, and the present invention is not limited by what has been particularly shown and described hereinabove. Rather the scope of the invention includes both combinations and sub-combinations of the various features described hereinabove, as well as variations and modifications thereof which would occur to persons skilled in the art upon reading the foregoing description and which are not disclosed in the prior art.

What is claimed is:

1. A computer server system, comprising:
a memory configured to store data across memory locations;
multiple processing cores including respective local caches in which to cache cache-lines read from the memory;
an interconnect configured to:
manage read and write operations of the memory and the local caches;
maintain local cache location data of the cached cache-lines according to respective ones of the memory locations from which the cached cache-lines were read from the memory;
receive a write request for a data element to be written to one of the memory locations;
find a local cache location in which to write the data element responsively to the local cache location data and the memory location of the write request; and
send an update request to a first one of the processing cores to update a respective first one of the local caches with the data element responsively to the found local cache location.

2. The system according to claim 1, wherein the first processing core is configured to update the first local cache with the data element responsively to the sent update request.

3. The system according to claim 1, wherein:
the interconnect includes a directory configured to store the local cache location data of the cached cache-lines according to respective ones of the memory locations of the cached cache-lines; and
the interconnect is configured to query the directory responsively to the memory location of the write request yielding the found local cache location.

4. The system according to claim 1, further comprising an interface controller configured to:
receive a packet from at least one device, the packet comprising the data element; and
generate the write request.

5. The system according to claim 4, wherein the interface controller is configured to tag the write request with an indication to push the data element to the first local cache even though local cache locations are unknown to the interface controller.

6. The system according to claim 4, wherein the interface controller is configured to:
classify the received packet responsively to header data of the received packet;
find one of the memory locations to which to write the data element of the received packet responsively to the classification of the received packet; and
generate the write request for the data element responsively to the found memory location.

7. The system according to claim 6, wherein the interface controller is configured to:
find a queue for the received packet responsively to the classification of the received packet;
find a buffer descriptor for the received packet responsively to the found queue; and
find the memory location to which to write the data element of the received packet responsively to the found buffer descriptor.

8. The system according to claim 4, wherein the interface controller comprises a network interface controller to manage receiving packets over a network, the at least one device comprising at least one node in the network.

9. The system according to claim 4, wherein the interface controller comprises a peripheral device controller and the at least one device includes at least one peripheral device.

10. The system according to claim 9, wherein the at least one peripheral device includes one or more of the following: a disk drive; or a hardware accelerator.

11. A computer server method, comprising:
storing data in a memory across memory locations;
caching cache-lines read from the memory in local caches of multiple processing cores;
managing read and write operations of the memory and the local caches;
maintaining local cache location data of the cached cache-lines according to respective one of the memory locations from which the cached cache-lines were read from the memory;
receiving a write request for a data element o be written to one of the memory locations;
finding a local cache location in which to write the data element responsively to the local cache location data and the memory location of the write request; and
sending an update request to a. first one of the processing cores to update a respective first one of the local caches with the data element responsively to the found respective local cache location.

12. The method according to claim 11, further comprising updating the first local cache with the data element responsively to the sent update request.

13. The method according to claim 11, further comprising:
storing in a directory the local cache location data of the cached cache-lines according to respective ones of the memory locations of the cached cache-lines; and
querying the directory responsively to the memory location of the write request yielding the found local cache location.

14. The method according to claim 11, further comprising:
receiving a packet from at least one device, the packet comprising the data element; and
generating the write request.

15. The method according to claim 14, further comprising tagging, by an interface controller, the write request with an indication to push the data element of the packet to the first local cache even though local cache locations are unknown to the interface controller.

16. The method according to claim 14, further comprising:
classifying the received packet responsively to header data of the received packet;
finding one of the memory locations to which to write the data element of the received packet responsively to the classification of the received packet; and
generating the write request for the received packet responsively to the found memory location.

17. The method according to claim 16, further comprising:
finding a queue for the received packet responsively to the classification of the received packet;
finding a buffer descriptor for the received packet responsively to the found queue; and
finding the memory location to which to write the data element of the received packet responsively to the found buffer descriptor.

18. The method according to claim 14, wherein the receiving the packet is performed by a network interface controller, the method further comprising the network interface controller managing receiving packets over a network, the at least one device comprising at least one node in the network.

19. The method according to claim 14, wherein the receiving the packet is performed by a peripheral device controller and the at least one device includes at least one peripheral device.

20. The method according to claim 19, wherein the at least one peripheral device includes one or more of the following: a disk drive; or a hardware accelerator.
